(19) United States
(12) Patent Application Publication
(10) Pub. No.: US 2017/0006173 A1
(43) Pub. Date: Jan. 5, 2017

(54) IMAGE GENERATION APPARATUS

(71) Applicant: Konica Minolta, Inc., Tokyo (JP)

(72) Inventors: Shigeyuki Ueda, Tokyo (JP); Masao Hosono, Toyohashi-shi (JP); Hozuma Nakajima, Toyokawa-shi (JP); Kenzo Yamamoto, Toyohashi-shi (JP)

(73) Assignee: Konica Minolta, Inc., Tokyo (JP)

(21) Appl. No.: 15/190,288

(22) Filed: Jun. 23, 2016

(30) Foreign Application Priority Data
Jun. 30, 2015 (JP) 2015-131431

(51) Int. Cl. H04N 1/00; G06F 3/0484; G06F 3/0482; G06F 3/0488

(52) U.S. Cl. CPC H04N 1/00469; G06F 3/04886; G06F 3/04845; H04N 1/00392; H04N 1/00413; G06F 3/0482; H04N 1/00411; H04N 1/00482; H04N 1/00384; G06F 2203/04805; H04N 2201/0094

(57) ABSTRACT

An image generation apparatus includes: a touch panel; an enlarged display unit that enlarges an image within a predetermined range from a touch position and overlaps the enlarged image with an original screen display on a display screen of the touch panel; an acceptance unit that accepts a button operation within an enlarged display area; and a correspondence display unit that produces a correspondence display with correspondence between a button displayed in the enlarged display area and a non-enlarged portion of the button.

The entire disclosure of Japanese Patent Application No. 2015-131431 filed on Jun. 30, 2015 including description, claims, drawings, and abstract are incorporated herein by reference in its entirety.

### BACKGROUND OF THE INVENTION

Field of the Invention

The present invention relates to an image generation apparatus, more specifically, to a technique for facilitating operation of a small-sized panel at a low development cost.

Description of the Related Art

In general, multi-function image generation apparatuses called MFP (Multi-Function Peripheral) have a large number of basic common functions among various models. Accordingly, displaying a common screen among various models on an operation panel to accept user operations makes it possible to suppress the development cost of a user interface.

However, the size of the operation panel varies largely depending on the size of the apparatus main body. When the screen display is simply enlarged or reduced to the panel size, the characters and the buttons are displayed in smaller sizes on the small-sized panel. This makes the display less visible or the buttons hard to operate, thereby causing the user to press by mistake the button next to the right button (see FIG. 20).

To solve the problem, there is proposed a measure by which, when the user touches the operation panel, the display is enlarged at the touch position and its surroundings (hereinafter, called “magnifying-glass enlargement”) to accept the user's next touch operation. According to this measure, the characters at the touch position and its surroundings become visible by the magnifying-glass enlargement, and the buttons become easy to operate by the magnifying-glass enlargement.

In addition, there is also a technique for, when the head of a character string is included at the touch position and its surroundings, enlarging the entire character string (for example, refer to JP 2010-039614 A and JP 2000-148341 A). This technique allows a selected character string to be enlarged and be easy to view.

However, when no characters are displayed but buttons are displayed at the touch position and its surroundings, the magnifying-glass enlarged buttons may become hard to identify (see FIGS. 21A and 21B). This may cause the user to touch an incorrect button instead of the desired button, thereby leading to erroneous operation.

### SUMMARY OF THE INVENTION

The present invention has been made in light of the foregoing problem, and an object thereof is to provide an image generation apparatus that facilitates panel operation with the magnifying-glass enlargement.

To achieve the abovementioned object, according to an aspect, an image generation apparatus reflecting one aspect of the present invention comprises: a touch panel; an enlarged display unit that enlarges an image within a predetermined range from a touch position and overlaps the enlarged image with an original screen display on a display screen of the touch panel; an acceptance unit that accepts a button operation within an enlarged display area; and a correspondence display unit that produces a correspondence display with correspondence between a button displayed in the enlarged display area and a non-enlarged portion of the button.

### BRIEF DESCRIPTION OF THE DRAWINGS

The above and other objects, advantages and features of the present invention will become more fully understood from the detailed description given hereinbelow and the appended drawings which are given by way of illustration only, and thus are not intended as a definition of the limits of the present invention, and wherein:

FIG. 1 is a perspective external view of main components of an image generation apparatus 1;

FIG. 2 is a block diagram of main components of an operation panel 100 and a control unit 110;

FIGS. 3A and 3B are tables describing information necessary for operation of the control unit 110, FIG. 3A showing an enlargement information table and FIG. 3B showing a button information table;

FIG. 4 is a flowchart of a main operation of the control unit 110;

FIG. 5 is a diagram describing a condition for magnifying-glass enlargement;

FIGS. 6A and 6B are diagrams illustrating examples of enlarged display of colored buttons, FIG. 6A showing the display state of magnifying-glass enlargement and FIG. 6B showing the operation in an enlarged area;

FIGS. 7A to 7D are diagrams illustrating an example of a duplexing/page aggregation screen, FIG. 7A showing the display state before enlargement, FIG. 7B showing the display state after enlargement, FIG. 7C showing the display state after enlargement of the buttons, and FIG. 7D showing the display state after magnifying-glass enlargement;

FIGS. 8A to 8D are diagrams illustrating an example of an executed job screen, FIG. 8A showing the display state before enlargement, FIG. 8B showing the display state after enlargement of the buttons, FIG. 8C showing the display state after enlargement of the buttons with a set enlargement factor, and FIG. 8D showing the display state after magnifying-glass enlargement;

FIG. 9A is a diagram illustrating a modification example in which only the frame is colored, and FIG. 9B is a diagram illustrating a modification example in which the colored portions of the buttons blink;

FIG. 10 is a flowchart of an operation executed by the control unit 110 to cause the colored portion of the button to blink;

FIG. 11 is a diagram illustrating examples of reference signs indicative of the correspondence between buttons inside and outside an enlarged display area;

FIG. 12 is a diagram illustrating an example of enlarged display in which character strings are displayed in buttons;

FIGS. 13A and 13B are diagrams illustrating the case where the same character string is displayed in a plurality of buttons, FIG. 13A showing the display state before enlargement and FIG. 13B showing the display state after enlargement;

FIGS. 14A and 14B are diagrams illustrating the case where the number of buttons in a range to be enlarged and no buttons other than the two buttons is displayed around the range to be enlarged, FIG. 14A showing the display state before enlargement and FIG. 14B showing the display state after enlargement;

FIG. 15 is a flowchart of an operation of the control unit 110 when characters are included in buttons or no other button is displayed around the range to be enlarged;

FIGS. 16A and 16B are diagrams illustrating the case where additional indications are provided to buttons, FIG. 16A showing the display state before enlargement and FIG. 16B showing the display state after enlargement;

FIG. 17 is a flowchart of an operation of the control unit 110 when additional indications are provided to buttons;

FIGS. 18A and 18B are diagrams illustrating an example of a display screen having a preview area, FIG. 18A showing the display state before enlargement and FIG. 18B showing the display state after enlargement;

FIG. 19 is a flowchart of an operation of the control unit 110 for moving the enlarged display area;

FIG. 20 is a diagram describing operability of the screen simply reduced to the panel size; and

FIGS. 21A and 21B are diagrams illustrating the case where no character is included in enlarged portions of magnifying-glass enlarged buttons, FIG. 21A showing the display state before enlargement and FIG. 21B showing the display state after enlargement.

### DESCRIPTION OF THE PREFERRED EMBODIMENTS

Hereinafter, an embodiment of an image generation apparatus according to the present invention will be described taking an image formation apparatus as an example with reference to the drawings. However, the scope of the invention is not limited to the illustrated examples.

### [1] Configuration of the Image Formation Apparatus

First, a configuration of the image formation apparatus according to the embodiment will be explained.

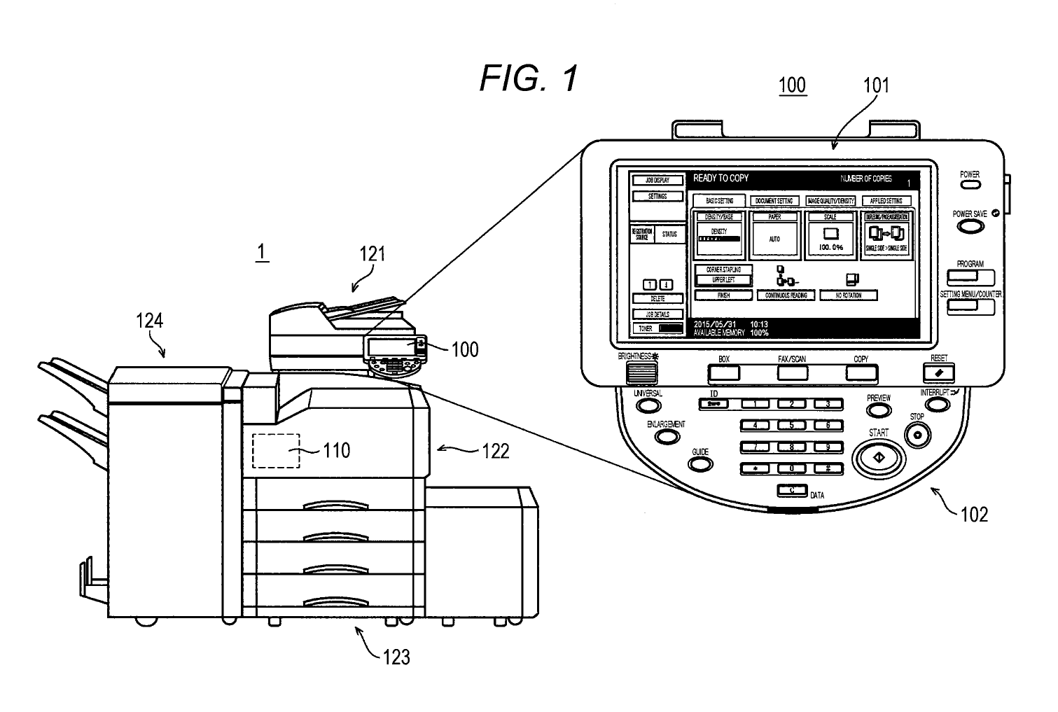

As illustrated in FIG. 1, an image formation apparatus 1 is a digital color multifunction peripheral composed of an image reading unit 121, an image formation unit 122, a paper feed unit 123, and a post-processing unit 124.

The image reading unit 121 has an automatic document feeder (ADF) to read images from each document placed on a document tray and generate digital image data. The generated digital image data is stored in a control unit 110 included in the image formation unit 122. The control unit 110 is a built-in system that controls the entire operation of the image formation apparatus 1.

The image formation unit 122 uses the image data generated by the image reading unit 121 and image data received via a communication network (not illustrated) such as a LAN (Local Area Network) to form images on record sheets supplied from the paper feed unit 123. The paper feed unit 123 has a paper feed cassette storing the record sheets and supplies the record sheets one by one to the image formation unit 122.

The post-processing unit 124 performs post-processing such as stapling or punching on the record sheets on which image formation has been completed by the image formation unit 122, and ejects the record sheets onto the paper ejection tray. The image formation apparatus 1 also includes an operation panel (OP) 100. The operation panel 100 has a touch panel unit 101 and hard keys 102. The touch panel unit 101 is composed of a touch pad 101p that detects the user's touch operation and a liquid crystal display (LCD) 101d that displays images.

The hard keys 102 are a numeric keypad, a start key, a reset key, and others, for example.

### [2] Configuration of the Control Unit 110

Next, a configuration of the control unit 110 will be explained.

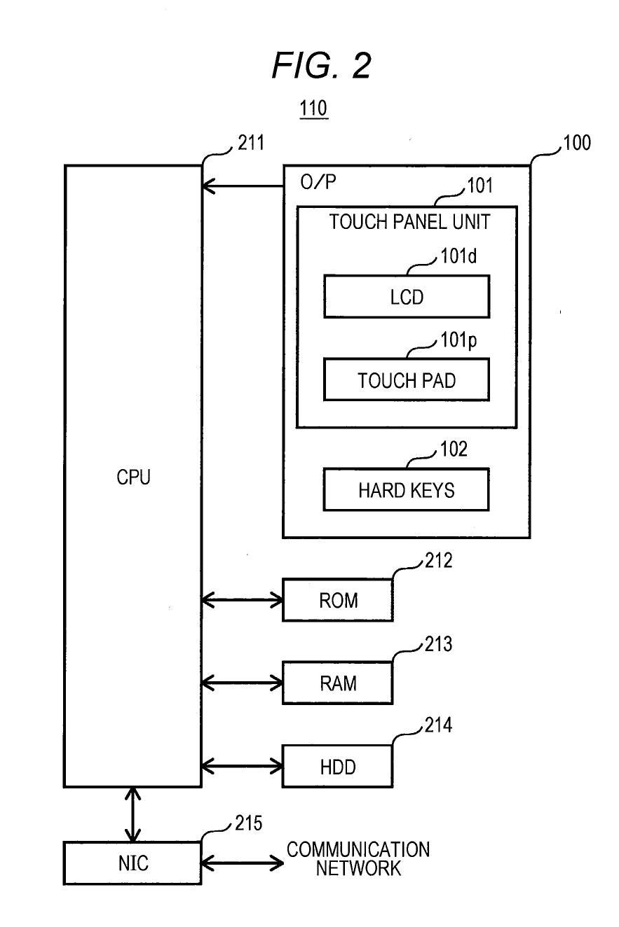

As illustrated in FIG. 2, the control unit 110 includes a CPU (central processing unit) 211, a ROM (read only memory) 212, and others. When the image formation apparatus 1 is powered on, a boot program is read from the ROM 212 and started, and then a control program is read from an HDD (hard disk drive) 214 with a RAM (random access memory) 213 as a working storage area. The control unit 110 accesses a communication network using a NIC (network interface card) 215 to accept print jobs.

The control unit 110 controls the liquid crystal display 101d of the operation panel 100 to provide information to the user and detect a touch operation on the touch pad 101p to accept the user operation, for example. Accordingly, a display screen stored in advance in the control unit 110 appears on the liquid crystal display 101d and a touch operation on a button displayed on the liquid crystal display 101d is detected.

As the RAM 213, a SRAM (static RAM) may be used or a non-volatile RAM with a backup power source such as a battery or a capacitor may be used. The image forming operation of the image formation apparatus 1 may be controlled via a dedicated printer controller. Further, a clock IC (integrated circuit) may be installed to perform time management such as the management of operation mode of the image formation apparatus 1.

### [3] Operations of the Control Unit 110

Next, operations of the control unit 110 will be explained.

For normal screen display, the control unit 110 stores in advance common screen data among various models in the HDD 214 for common screen display among the models, and enlarges or reduces the screen display to the screen size of the liquid crystal display 101d. In addition, when a plurality of buttons is displayed in a predetermined range from the position of touch by the user on the normal screen, the control unit 110 enlarges the range and overlaps the same with the normal screen. This enlargement is magnifying-glass enlargement (also called magnifying-lens display).

In the embodiment, the range of the magnifying-glass enlargement on the normal screen will be called “range to be enlarged,” and the area where the range to be enlarged is displayed under the magnifying-glass enlargement will be called “enlarged display area.” The range to be enlarged and the enlarged display area are concentric with each other and are circular in shape. The control unit 110 stores central coordinates (Xm, Ym), radius Rm1 of the range to be enlarged, and radius Rm2 of the enlarged display area. The ratio between these radiuses is enlargement factor M.

[Equation 1]

M=Rₘ₂/Rₘ₁ (1)

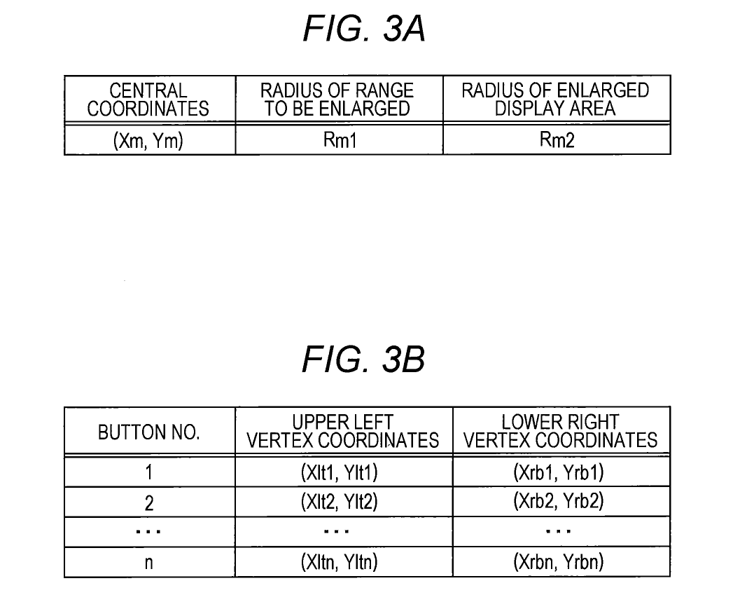

The radiuses Rm1 and Rm2 are set in advance. The central coordinates (Xm, Ym) indicate the position of a touch by the user. The control unit 110 stores the central coordinates and the radiuses in an enlargement information table as illustrated in FIG. 3A. With no enlarged display, the control unit 110 stores coordinates outside the normal screen (hereinafter, called “invalid coordinates”) as central coordinate values and displays that matter.

For each of n buttons displayed on the normal screen, a rectangular detection area for determining whether the button is touched is set by the coordinates of vertexes at diagonal positions, in the embodiment, upper left vertex coordinates (Xlt, Ylt) and lower right vertex coordinate (Xrb, Yrb). The control unit 110 stores the respective sets of vertex coordinates for the buttons in a button information table as illustrated in FIG. 3B.

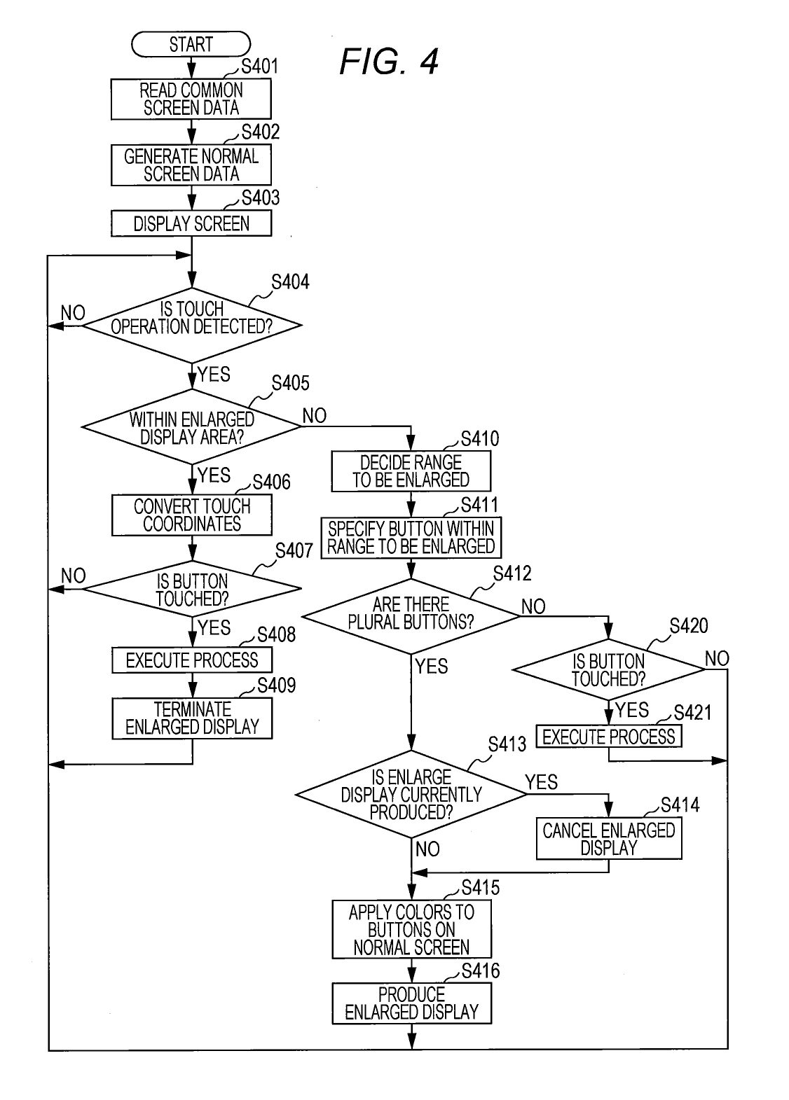

As illustrated in FIG. 4, the control unit 110 reads the common screen data from the HDD 214 (S401), generates display screen data in which the common screen data is enlarged or reduced according to the screen size of the liquid crystal display 101d (S402), and displays the generated display screen data on the liquid crystal display 101d (S403).

After that, when detecting a touch operation on the touch pad 101p (S404: YES), the control unit 110 determines whether the touch position falls within the enlarged display area. Specifically, when the distance between the touch coordinates and the central coordinates in the enlarged display area is equal to or smaller than the radius of the enlarged display area, the control unit 110 determines that the touch position falls within the enlarged display area.

When the touch position falls within the enlarged display area (S405: YES), the control unit 110 determines which position in the range to be enlarged corresponds to the touch position (hereinafter, called “normal coordinates”) by converting the touch coordinates to the normal coordinates (S406). The touch coordinates (Xt, Yt) can be converted to the normal coordinates (Xn, Yn) by the following expressions (2) and (3):

$$\begin{matrix}[ Equation 2 ] & \\ {X}_{n} = ( {X}_{t} - {X}_{m 2} ) \times \frac{{R}_{m 1}}{{R}_{m 2}} + {X}_{0} & ( 2 ) \\ {Y}_{n} = ( {Y}_{t} - {Y}_{m 2} ) \times \frac{{R}_{m 1}}{{R}_{m 2}} + {Y}_{0} & ( 3 )\end{matrix}$$

Next, the control unit 110 determines whether any of the buttons is touched depending on whether the normal coordinates (Xn, Yn) of the touch position fall within the touch detection area for any of the buttons. Specifically, the control unit 110 compares the vertex coordinates (Xlt, Ylt) and (Xrb, Yrb) for the individual buttons to the normal coordinates (Xn, Yn) of the touch position.

[Equation 3]

Xᵢₜ≦Xₙ≦X_{rb} (4)

Yᵢₜ ≦Yₙ≦Y_{rb} (5)

The touched button satisfies both the foregoing expressions (4) and (5).

When determining that the button is touched (S407: YES), the control unit 110 executes the process corresponding to the button (S408), and terminates the enlarged display (S409). To terminate the enlarged display, the control unit 110 displays the normal screen in the enlarged display area and then returns the colored display of the buttons to the normal display. After step S409, or when no button is touched (S407: NO), the control unit 110 returns to step S404 to repeat the foregoing process.

When the touch position does not fall within the enlarged display area (S405: NO), the control unit 110 decides a circular area with a radius Rd. centered on the touch coordinates (Xt, Yt) as the range to be enlarged (S410). Then, the control unit 110 specifies all the buttons satisfying the following expressions (6) to (8) (S411).

[Equation 49

x²+y²≦R₀² (6)

Xₛᵢ≦x≦Xₑₜ (7)

Yₛᵢ≦y≦Yₑₜ (8)

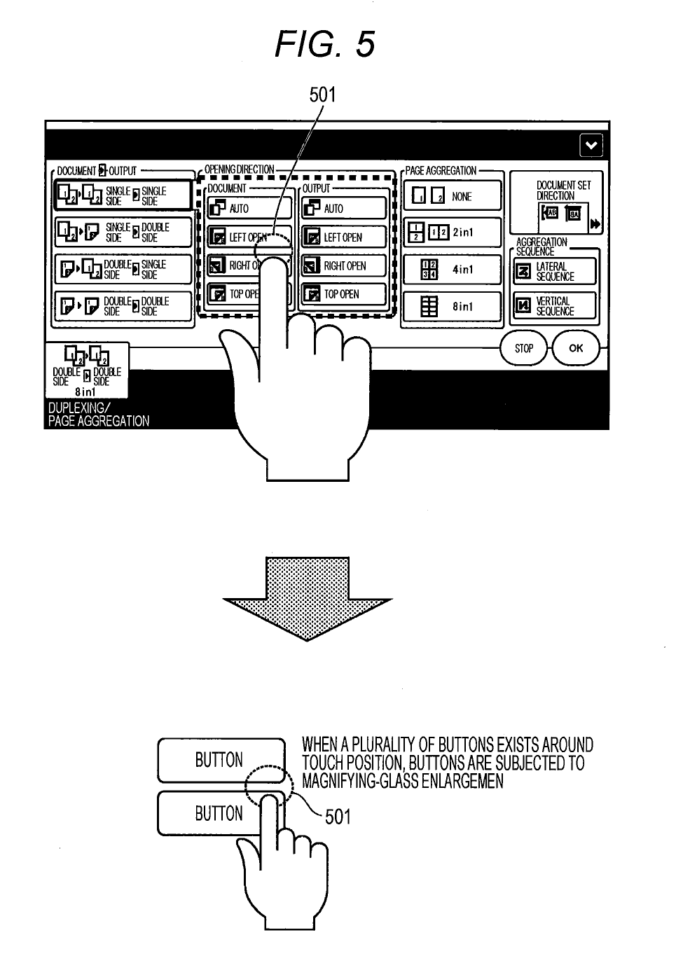

In the embodiment, as illustrated in FIG. 5, the magnifying-glass enlargement is carried out only when a plurality of buttons exists in a circle 501 with a predetermined radius from the touch position.

When there is a plurality of buttons satisfying the foregoing expressions (6) to (8) (S412: YES), the control unit 110 refers to the enlargement information table to determine any enlarged display area is currently displayed. When the central coordinates (Xm, Ym) stored in the enlargement information table are not invalid coordinates, some enlarged display area is currently displayed (S413: YES). Thus, the control unit 110 displays the normal screen in the currently displayed enlarged display area, and replaces the central coordinates (Xm, Ym) with the invalid coordinates in the enlargement information table, and then terminates the enlarged display (S414).

After step S414 and when no enlarged display area is currently displayed (S413: NO), the control unit 110 applies different colors to the buttons specified at step 5411 on the normal screen (S415), and enlarges and displays the images in the range to be enlarged in the enlarged display area (S416). In this case, when the buttons have frames around them, the control unit 110 applies the colors to the portions inside the frames except for the characters. When the buttons have no frame and are displayed in background color different from the sections other than the buttons, the control unit 110 may apply different background colors to the buttons.

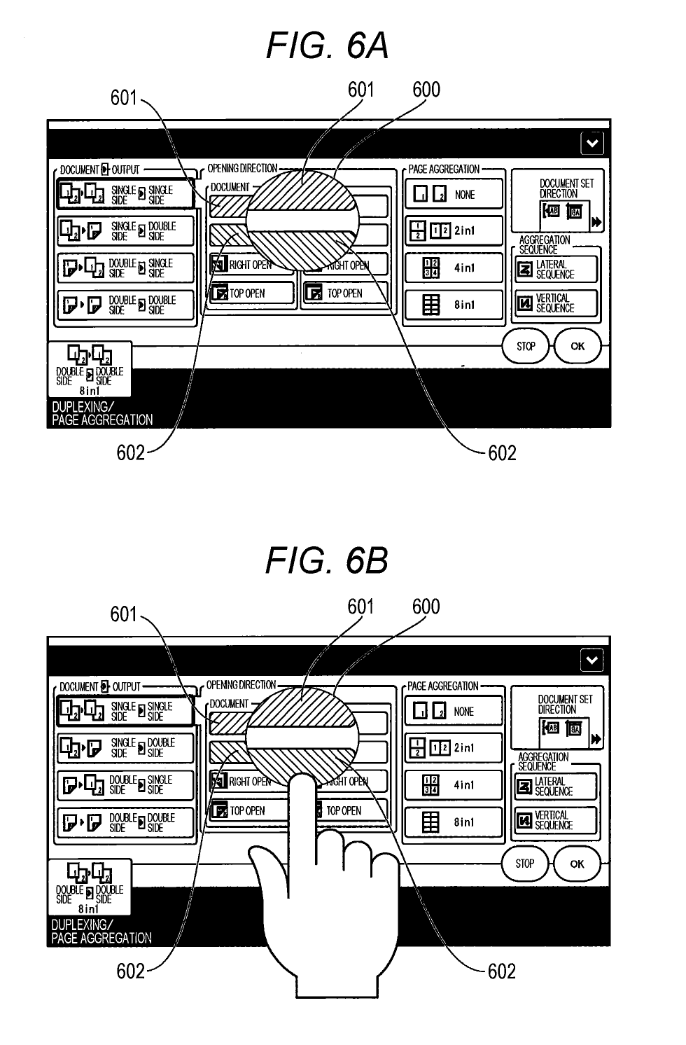

FIGS. 6A and 6B are diagrams illustrating examples of colored buttons. As illustrated in FIG. 6A, the image in the range to be enlarged centered on the touch position is enlarged and displayed in an enlarged display area 600. Accordingly, buttons 601 and 602 displayed in the range to be enlarged are also enlarged to facilitate the touch operation.

In addition, as illustrated in FIG. 6B, the same color is applied to the buttons 601 and 602 inside and outside the enlarged area, and it is easy to identify which buttons are enlarged. Therefore, it is possible to prevent the user from misidentifying the enlarged buttons and touching an undesired button by mistake.

When no plurality of buttons exists within the range to be enlarged (S412: NO), the control unit 110 uses the touch coordinates (Xt, Yt). When any button satisfies the following expressions (9) and (10):

[Equation 5]

Xᵢₜ≦Xₜ≦X_{rb} (9)

Yᵢₜ≦Yₜ≦Y_{rb} (10)

the control unit 110 determines that the button is touched (S420: YES), and executes the process corresponding to the button (S421). After step S421 and when no button is touched (S410: NO), the control unit 110 returns to step S404 to repeat the foregoing process.

In this manner, for each of buttons displayed in the enlarged display area, the same color is applied to the portion of the button displayed in the enlarged display area and the portion of the button displayed in an area other than the enlarged display area. Therefore, when it is not known which button is displayed only with reference to the enlarged display area, the corresponding portions of the same button inside and outside the enlarged display area can be identified by the color, and it is easy to determine which button is displayed with reference to the corresponding portions.

[4] Comparison with Other Enlarged Display Methods

To produce enlarged display for prevention of the press of the wrong button next to the desired button on the operation panel, there are methods such as simple enlargement and button enlargement as well as magnifying-glass enlargement. The simple enlargement is intended to enlarge part of the display screen to full screen. The button enlargement is intended to enlarge only the button selected by the user and overlap the enlarged button with the original screen.

The advantages of the magnifying-glass enlargement will be explained through comparison with the other methods, taking a look at specific display examples.

(1) Duplexing/Page Aggregation Screen

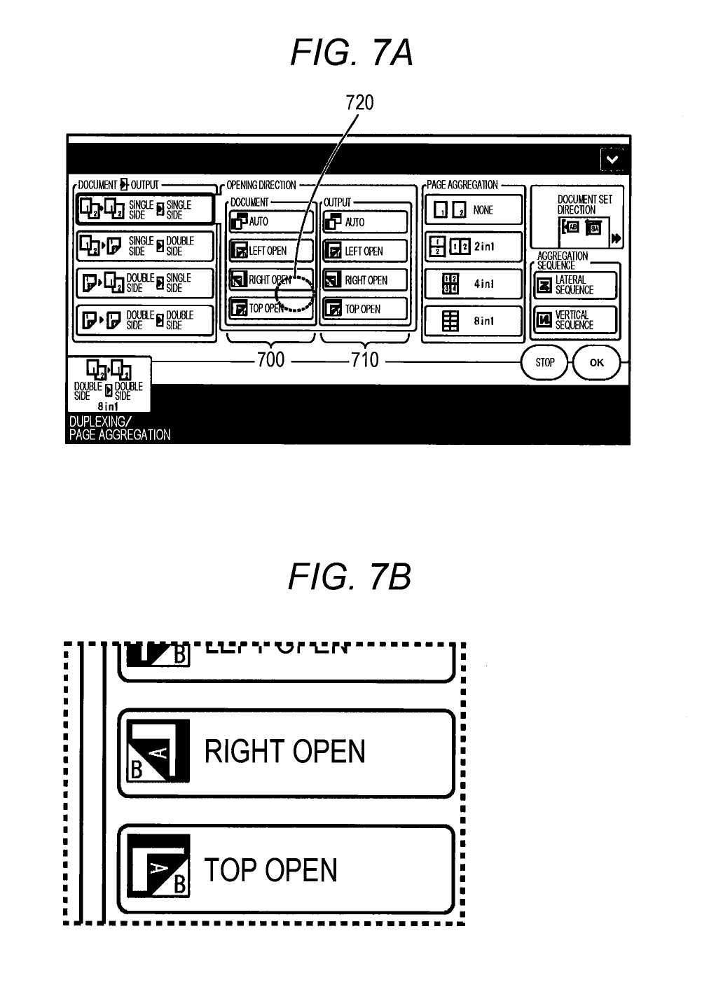

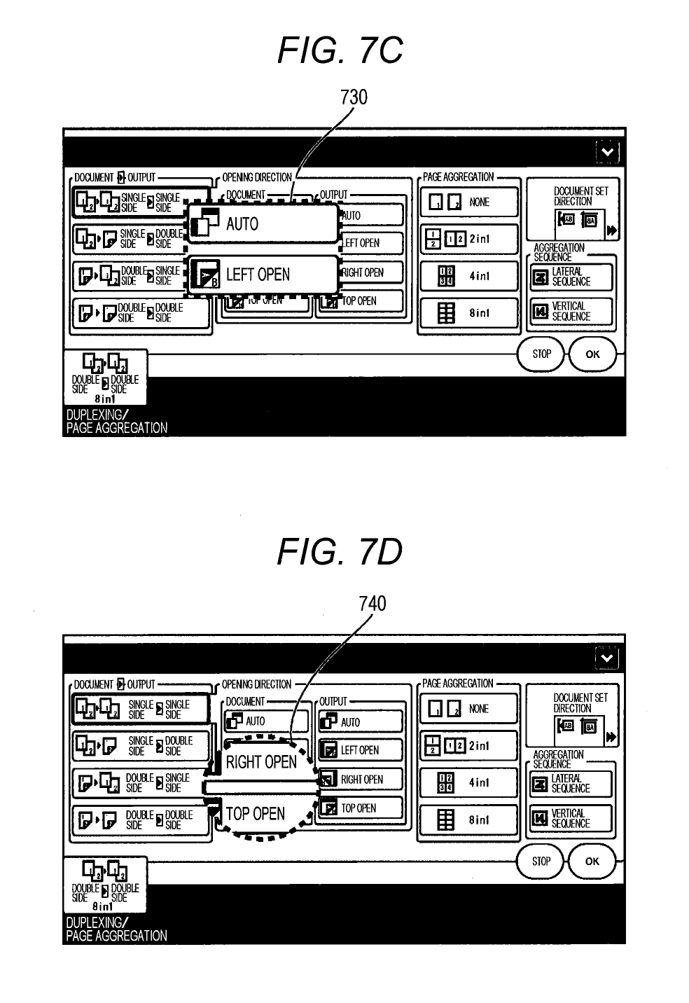

The operation screens at the image formation apparatus include a duplexing/page aggregation screen that accepts specifications of duplex printing or page aggregation printing such as 2-in-1 printing. The duplexing/page aggregation screen includes buttons “auto,” “left open,” “right open,” “top open” for selecting four opening directions of both “document” 700 and “output” 710 as illustrated in FIG. 7A. Accordingly, the user has to perform panel operations while being conscious for which of the “document” and “output” the opening direction is to be selected.

In this case, when a range to be enlarged 720 centered on the touch position is simply enlarged to full screen, the characters “document” and “output” extend off the display screen as illustrated in FIG. 7B, and it is not possible to identify only from the screen display the buttons for which of the “document” and the “output” the opening direction is to be selected. As a result, the user finds difficulty in performing operations or makes a mistake in performing operations.

Meanwhile, in the button enlargement (see FIG. 7C) by which only the buttons within the range to be enlarged 720 or the magnifying-glass enlargement (see FIG. 7D) by which the range to be enlarged 720 is entirely enlarged, the characters “document” and “output” continue to be displayed outside enlarged display areas 730 and 740, and it is clearly indicated for which of “document” and “output” the buttons are intended to select the opening direction. Therefore, it is possible to prevent the user's erroneous operation.

In this sense, the button enlargement and the magnifying-glass enlargement are superior to the simple enlargement.

(2) Executed Job Screen

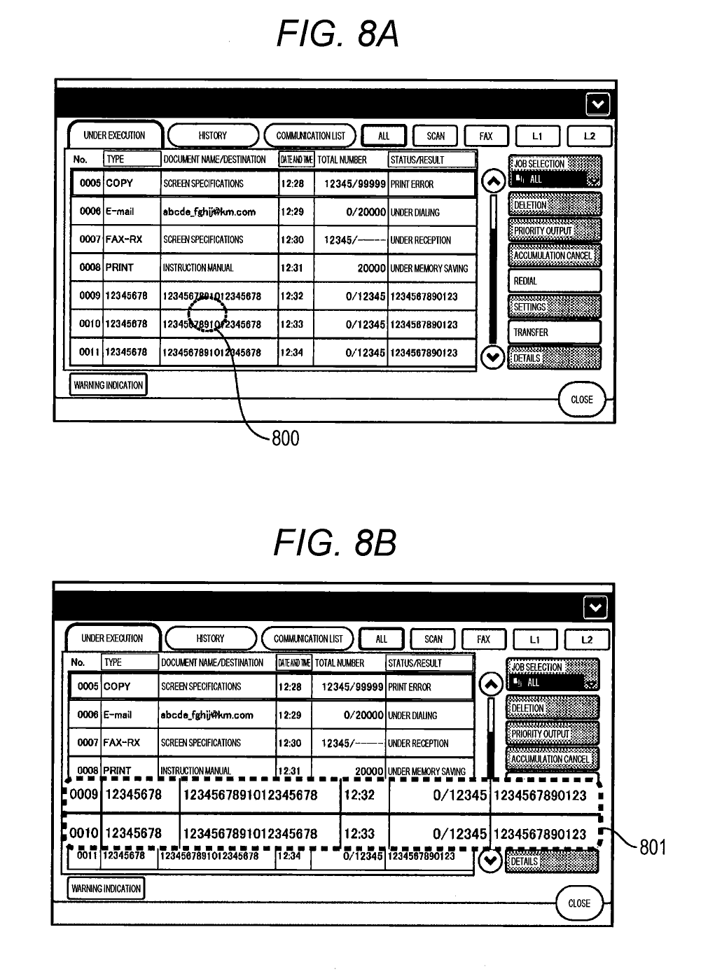

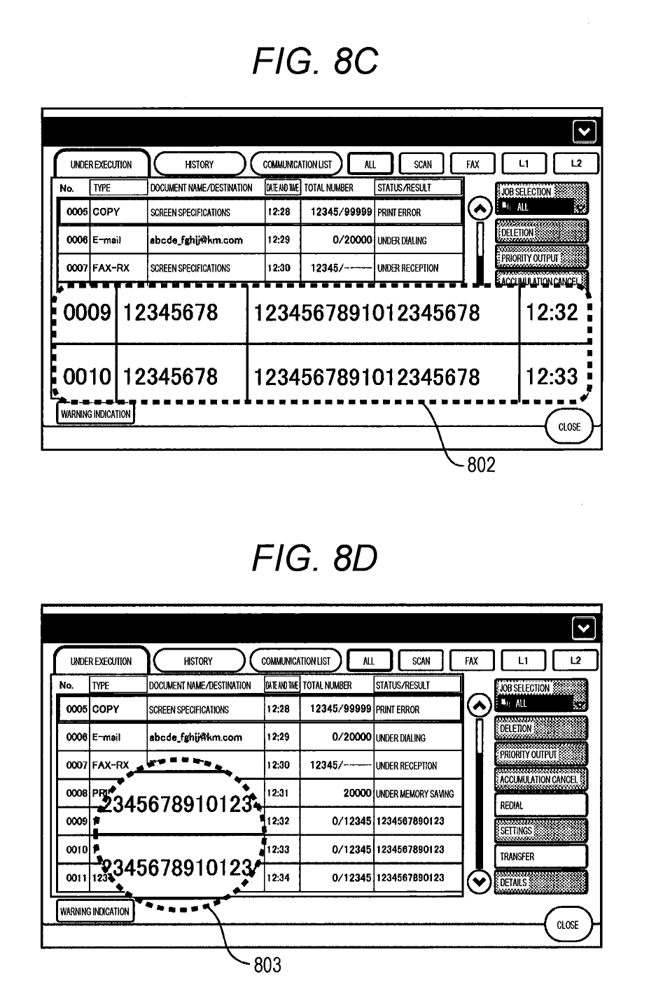

The executed job screen is a screen displaying a list of jobs being executed by the image formation apparatus (see FIG. 8A).

In the executed job screen, the fields in the lists constitute buttons. The fields are inevitably wide because it is necessary to display various kinds of information for the individual jobs. When the enlargement factor is uniformly limited such that the enlarged buttons can be entirely displayed within the screen, buttons 801 cannot be much enlarged (see FIG. 8B). Accordingly, the buttons do not become much higher, which is less effective to prevent the user from touching the wrong button next to the desired button by mistake.

To compensate for this disadvantage, it is considered to, instead of limiting uniformly the enlargement factor, set the enlargement factors and the post-enlargement display positions of the individual buttons in advance for each of the display screens, thereby to display buttons 802 in as a large size as possible, for example (see FIG. 8C). However, these settings need to be changed depending on the size of the liquid crystal display, and cannot be uniform regardless of the model of the image formation apparatus. This requires excessive development man-hours to make the settings for each model, which causes inevitably the increase of the development cost.

Meanwhile, in the magnifying-glass enlargement, the range specified by the user is enlarged and the buttons can be enlarged with the same enlargement factor regardless of the sizes of the buttons before the enlargement. In addition, the magnifying-glass enlargement can be performed only by setting the radius Rm1 of a range to be enlarged 800 and the radius Rm2 of an enlarged display area 803 depending on the size of the liquid crystal displays. This makes it possible to suppress the increase of the development cost and prevent reliably the press of the wrong button next to the desired button by mistake (see FIG. 8D).

In this sense, the magnifying-glass enlargement is superior to the button enlargement.

As described above, the magnifying-glass enlargement makes it possible to suppress the increase of the development cost for MFPs in which liquid crystal displays of various sizes are mounted depending on the models. In this sense, the image formation apparatus 1 employing the magnifying-glass enlargement according to the embodiment has the excellent effect of preventing the press of the wrong button next to the desired button at low cost regardless of the model of the MFP.

### [5] Modification Examples

The embodiment of the present invention has been explained so far. However, as a matter of course, the present invention is not limited to the foregoing embodiment but can be modified as described below.

(1) In the foregoing embodiment, the buttons are entirely colored. However, as a matter of course, the present invention is not limited to this. Instead of this, the correspondence between the buttons inside and outside the enlarged area may be shown in such manners as described below.

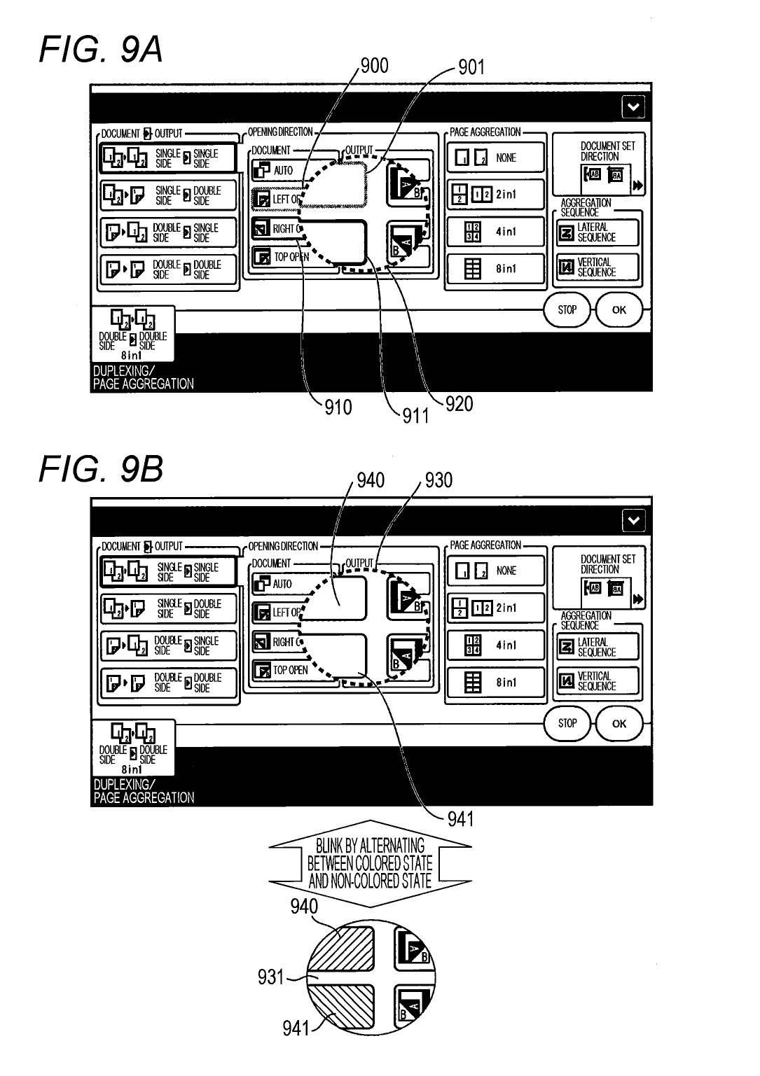

Specifically, instead of the entire buttons, only frames 900, 901, 910, and 911 of the buttons may be colored as illustrated in FIG. 9A. In this case, the correspondence between the buttons inside and outside an enlarged display area 920 can be shown by the different colors of the frames 900, 901, 910, and 911. Referring to FIG. 9A, the frame colors indicate that the frames 900 and 901 surround an identical button and the frames 910 and 911 surround another identical button.

The control unit 110 executes the operation of applying colors to only the frames of the buttons, instead of applying colors to the entire buttons, at step S415 of the flowchart described in FIG. 4.

Alternatively, the correspondence between the buttons inside and outside the enlarged display area may be shown by blinking. For example, when the entire buttons are colored, the colored buttons may blink as illustrated in FIG. 9B. An enlarged display area 930 shows the state in which buttons 940 and 941 are not colored (non-colored state), and an enlarged display area 931 shows the state in which the buttons 940 and 941 are colored (colored state). The display blinks by alternating repeatedly the colored state and the non-colored state.

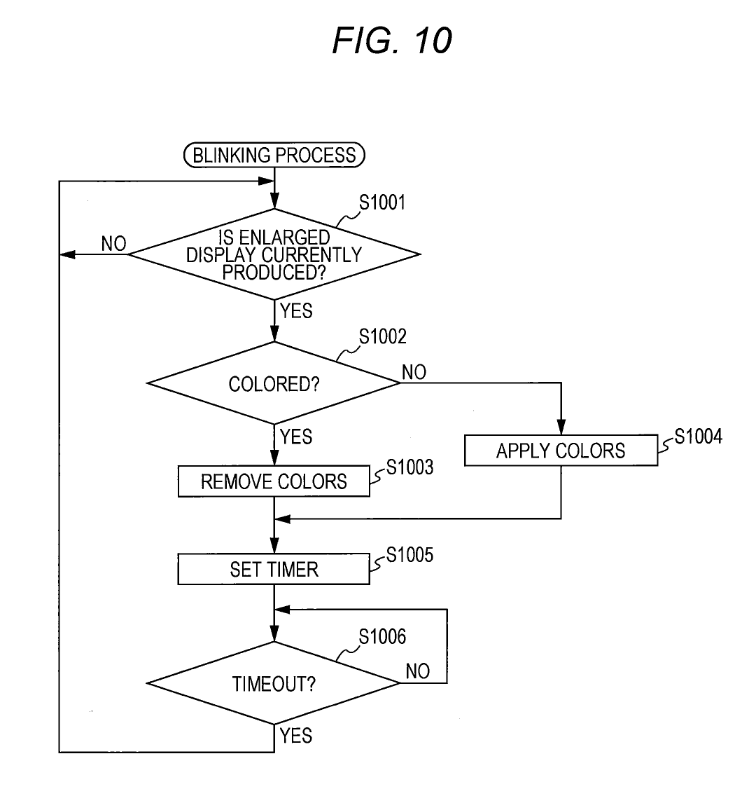

To make the display blink, the control unit 110 first determines whether the enlarged display is performed as described in FIG. 10. When the enlarged display is performed (S1001), the control unit 110 checks whether the buttons are colored. When the buttons are colored (S1002: YES), the control unit 110 removes the colors from the buttons (S1003). When the buttons are not colored (S1002: NO), the control unit 110 applies colors to the buttons (S1004).

After steps S1003 and S1004, the control unit 110 sets a timer according to the frequency of blinking of the colored display (S1005). When a timeout occurs (S1006: YES), the control unit 110 moves to step S1001 to repeat the foregoing process.

When the frames of the buttons are colored, the blinking display can be performed by applying or removing the colors. In this manner, it is easy to call the user's attention to the correspondence between the buttons, and it is possible to make the correspondence between the buttons further easier to understand.

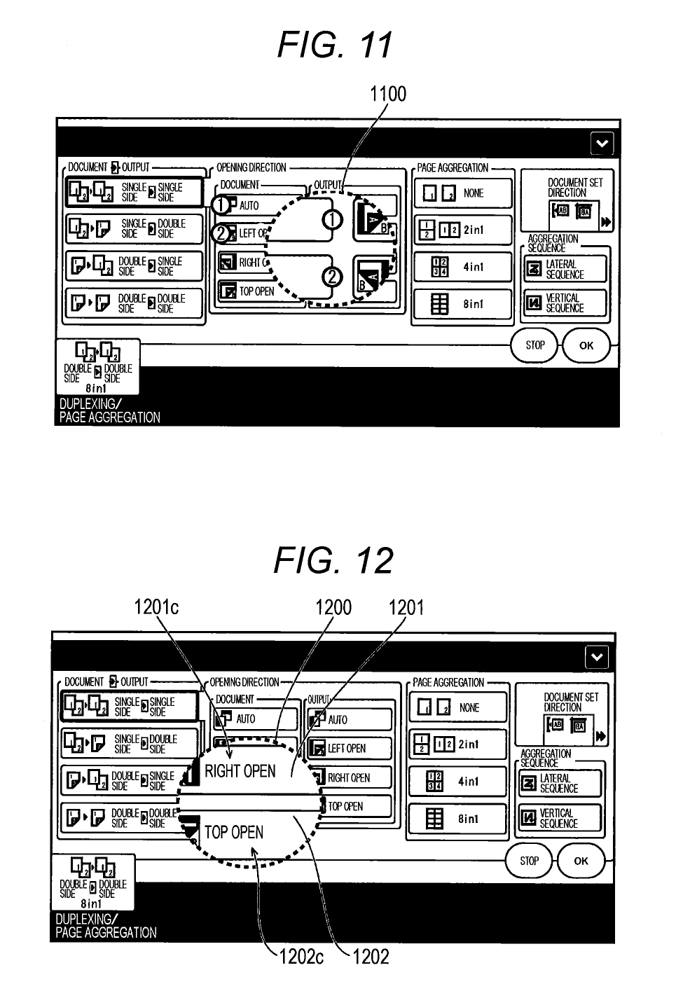

In addition, reference signs may be displayed to show the correspondence between the buttons inside and outside the enlarged display area. In particular, by using numbers as reference signs as illustrated in FIG. 11 and superimposing the same number on the same button inside and outside an enlarged display area 1100, it is possible to make the correspondence between the buttons easy to understand. By accepting the entry of the number through the numeric keypad included in the hard keys 102, the operation of the button with the number can be accepted to make the button operation further easy and reliable.

(2) In the foregoing embodiment, when a plurality of buttons exists within the range to be enlarged, the buttons are always colored. As a matter of course, the present invention is not limited to this but the following measure may be taken instead.

For example, as illustrated in FIG. 12, when character strings 1201c and 1202c are displayed on buttons 1201 and 1202 in an enlarged display area 1200, these buttons can be identified by the character strings 1201c and 1202c. Accordingly, no colors may be applied to the buttons 1201 and 1202 to show the correspondence between the buttons 1201 and 1202 inside and outside the enlarged display area 1200.

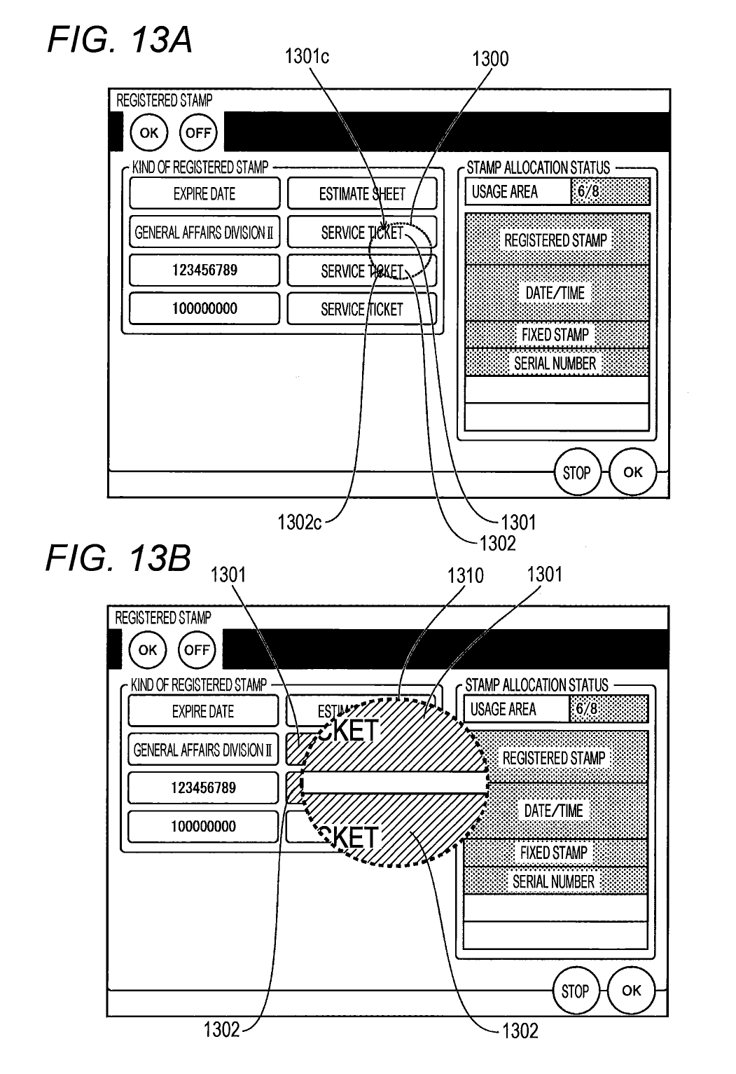

In addition, as illustrated in FIG. 13A, when identical character strings 1301c and 1302c are displayed on a plurality of buttons 1301 and 1302 displayed in a range to be enlarged 1300, the buttons cannot be identified by the character strings 1301c and 1302c. Accordingly, the buttons 1301 and 1302 are desirably colored to show the correspondence between the buttons 1301 and 1302 inside and outside an enlarged display area 1310 (FIG. 13B).

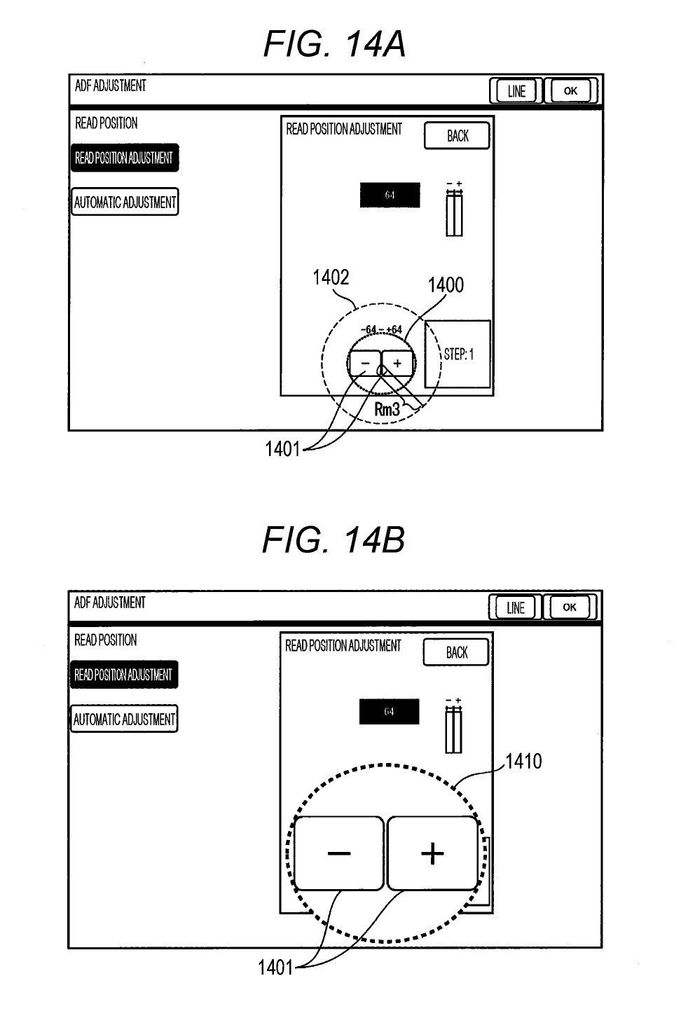

When the number of buttons 1401 within a range to be enlarged 1400 is two and no other button exists within a radius Rm3 from the central coordinates (Xm, Ym) (see FIG. 14A), no correspondence between the buttons inside and outside the enlarged display area 1410 is shown (see FIG. 14B). However, the radius Rm3 is a predetermined distance satisfying the following expression:

[Equation 6]

Rₘ₁<Rₘ₃ (11)

When no button is displayed in a circumferential area 1402 of the range to be enlarged 1400, the buttons 1401 can be clearly identified and therefore may not be colored because there is no fear that the user performs erroneous operation.

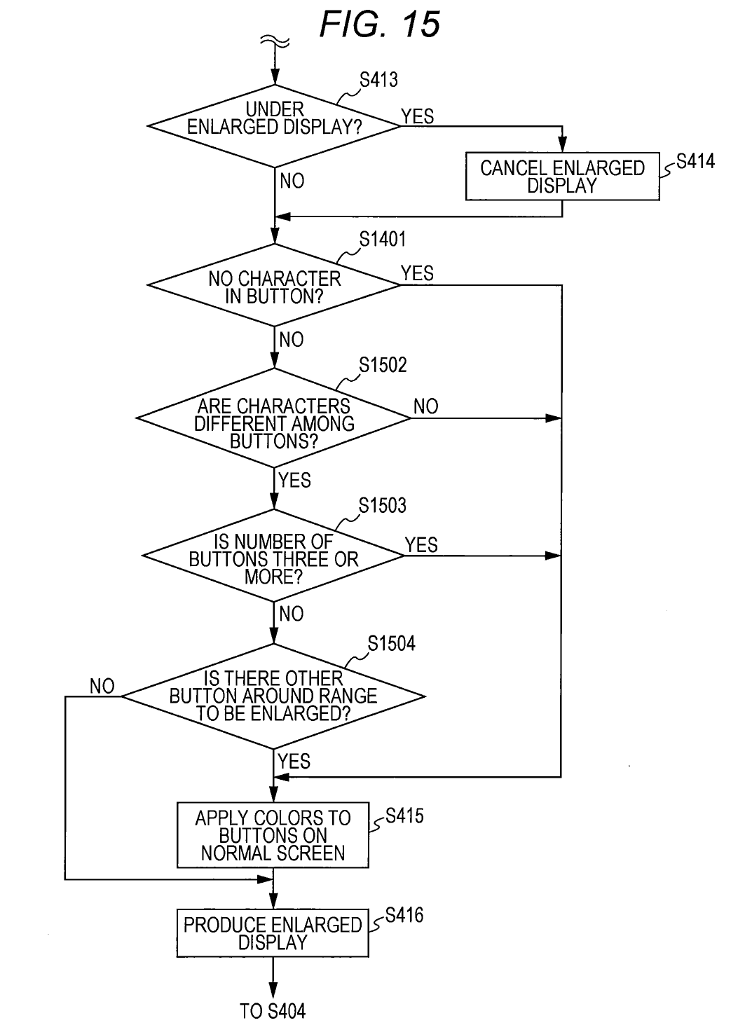

In the foregoing case, the control unit 110 may operate as described in FIG. 15. FIG. 15 is a flowchart of changed steps from the flowchart of FIG. 4. As described in FIG. 15, when NO at step S413 and when no characters are displayed on any of the buttons within the range to be enlarged after step S414 (S1501: YES), the control unit 110 applies the colors to the buttons on the normal screen (S415), and enlarges the buttons (S416).

When characters are displayed in all the buttons (S1501: NO), the control unit 110 compares the character strings in the buttons. When there is no difference between the character strings in the buttons (S1502: NO), the control unit 110 applies the colors to the buttons on the normal screen (S415), and enlarges the buttons (S416).

When the character strings are different among the buttons (S1502: NO), the control unit 110 counts the number of the buttons in the range to be enlarged. When the number is three or more (S1503: YES), the control unit 110 applies the colors to the buttons in the normal screen (S415), and enlarges the buttons (S416).

When the number of the buttons is two (S1503: NO), the control unit 110 checks whether there is any button not falling within the range to be enlarged but existing around the range to be enlarged. When there is such a button (S1504: YES), the control unit 110 applies the color to the buttons on the normal screen (S415) and enlarges the buttons (S416).

When there is no other button around the range to be enlarged (S1504: NO), the control unit 110 enlarges the buttons without applying the colors (S416).

(3) In the foregoing embodiment, the buttons are separately displayed. As a matter of course, the present invention is not limited to this. Some additional indications may be provided to the separate buttons as described below.

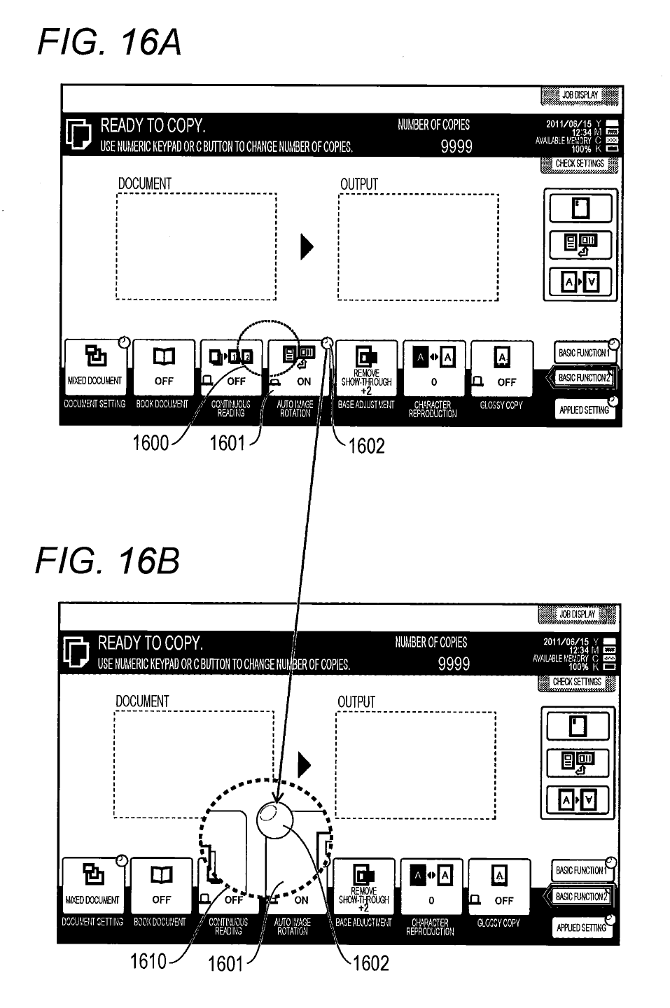

For example, there is a button such as a function batch button that is intended to make changes to the default settings and is displayed with an additional indication for a setting change when the setting change is currently made. FIG. 16A illustrates a button 1601 as a function batch button with an additional indication 1602 for a setting change made to the function.

Meanwhile, when the button 1601 falls within a range to be enlarged 1600 specified by the user and the additional indication 1602 for the button 1601 falls outside the range to be enlarged 1600, enlarging simply the range to be enlarged 1600 might make it difficult to determine whether the enlarged button 1601 is displayed with the additional indication 1602 (see FIG. 16A).

By displaying the additional indication 1602 within an enlarged display area 1610 as illustrated in FIG. 16B, it can be clarified that the button 1601 has the setting change. As a matter of course, the content of the additional indication 1602 is not limited to the setting change in the button 1601. Any additional indication for the content other than the setting change can be displayed within the enlarged display area 1610 to obtain the same effect.

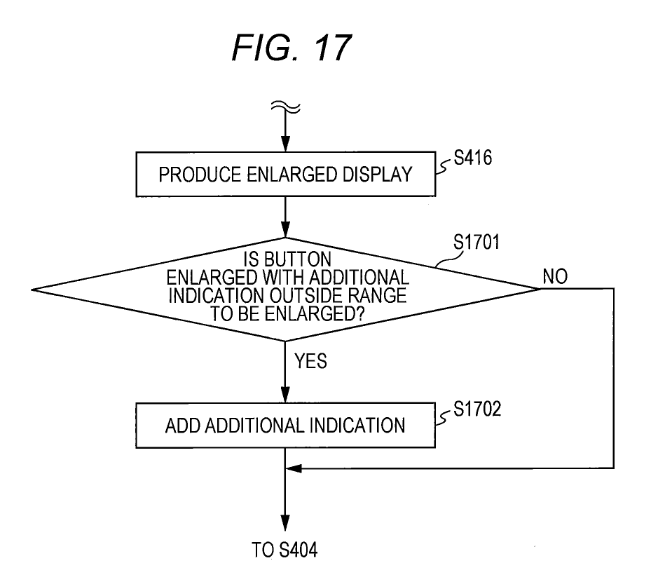

FIG. 17 is a flowchart of operation of the control unit 110 for enlarging the additional indication. As described in FIG. 17, the control unit 110 enlarges the buttons (S416) and determines whether any button with an additional indication outside the range to be enlarged is enlarged. When any button with an additional indication is enlarged (S1701: YES), the control unit 110 superimposes the additional indication on the portion of the button displayed in the enlarged display area (S1702).

(4) In the foregoing embodiment, the display screen has no preview area for displaying a preview image. As a matter of course, the present invention is not limited to this. The display screen may have a preview area as described below.

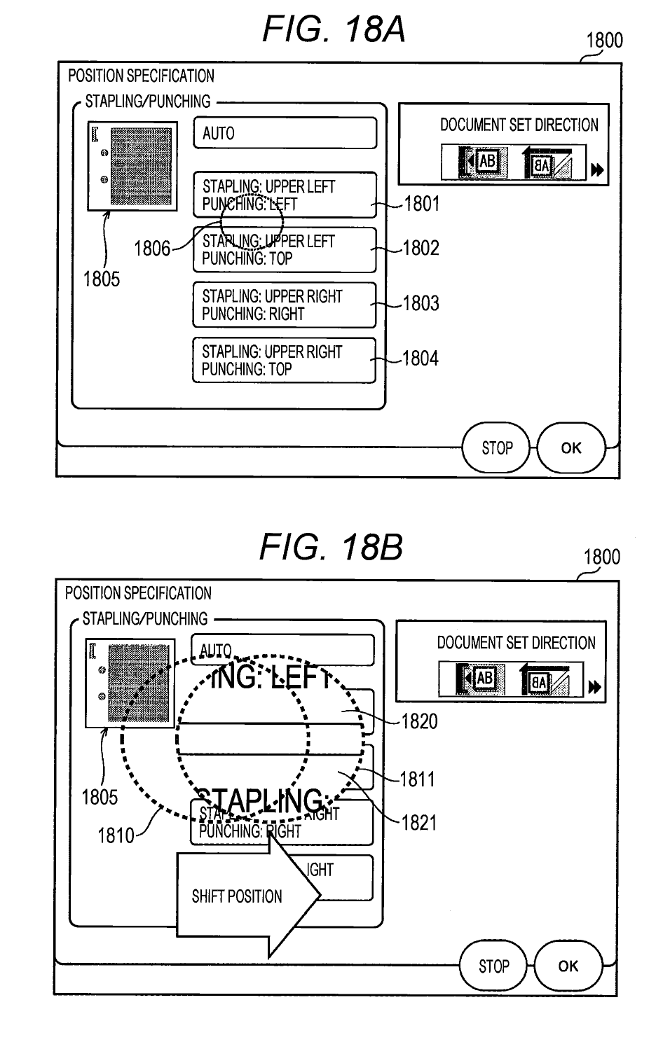

FIG. 18A illustrates a position specification screen 1800 having a preview area 1805 for displaying preview images describing the positions for stapling or punching as post-processing to be performed on the printed material on which image formation has been completed. When the user touches any of buttons 1801 to 1804 on the position specification screen 1800, a preview image indicating the stapling/punching position corresponding to the touched button is displayed in the preview area 1805.

When a range to be enlarged 1806 touched and specified by the user on the position specification screen 1800 is simply enlarged, central coordinates (Xm, Ym) are close to the preview area 1805 and the enlarged display area 1810 overlaps the preview area 1805 as illustrated in FIG. 18B. Accordingly, the preview image changed by touching enlarged buttons 1820 and 1821 becomes less visible.

To solve this problem, if the enlarged display area 1810 overlaps on the preview area 1805 when the portion touched by the user is enlarged as the central coordinates (Xm, Ym), the enlarged display may be performed in an enlarged display area 1811 not overlapping with the preview area 1805.

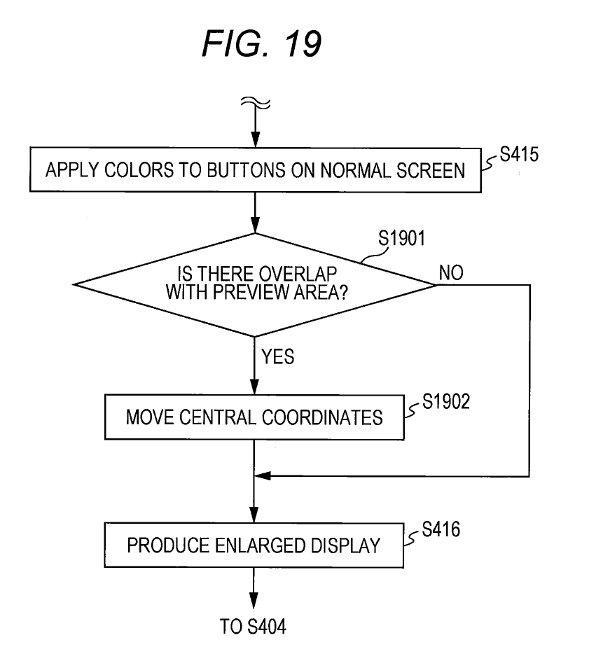

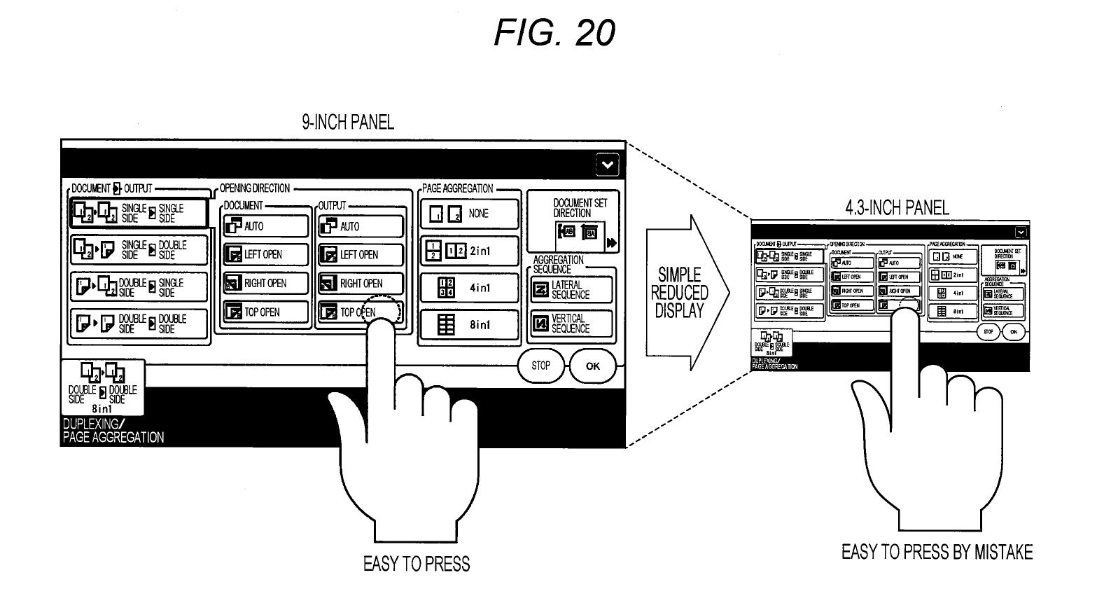

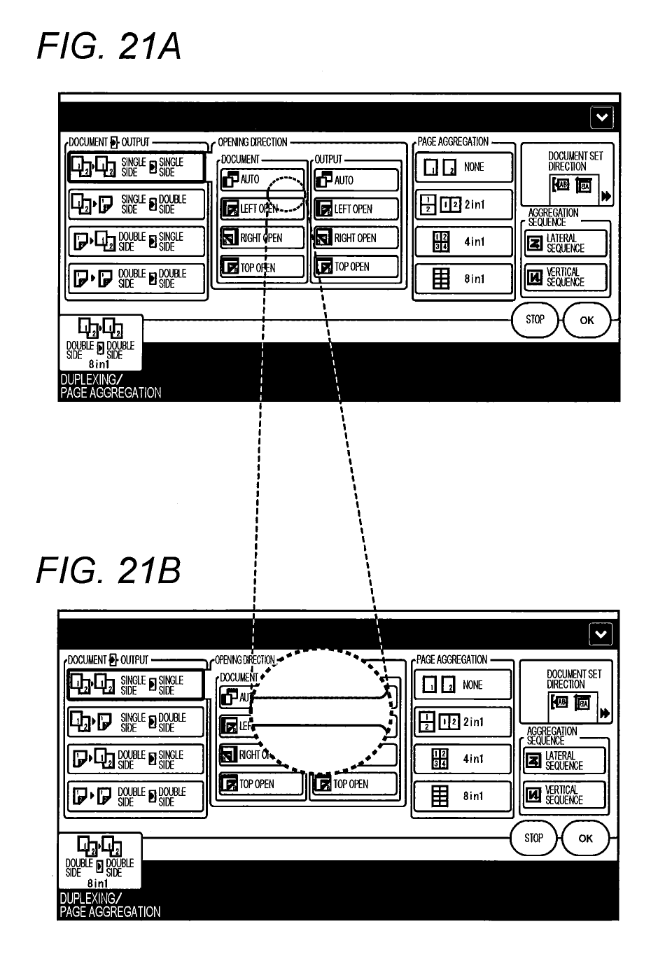

FIG. 19 is a flowchart of operation of the control unit 110 for moving the enlarged display area. The control unit 110 applies the colors to the buttons (S415), and checks whether the enlarged display area overlaps with the preview area. When the enlarge display area overlaps with the preview area (S1901: YES), the control unit 110 moves the central coordinates (Xm, Ym) such that the enlarged display area does not overlap with the preview area (S1902).

When the enlarged display area does not overlap with the preview area (S1901: NO) or after the completion of step S1902, the control unit 110 performs enlarged display (S416) and moves to step S404.

In this manner, it is possible to prevent the preview from being hidden by enlarged display, thereby allowing the user to perform screen operation in an easy manner.

(5) In the foregoing embodiment, enlarged display is performed only when a plurality of buttons falls within the range to be enlarged. As a matter of course, the present invention is not limited to this. The magnifying-glass enlargement may be performed even when the number of buttons falling within the range to be enlarged is one or less. In addition, the correspondence of the button inside and outside the enlarged display area may be shown by coloring or the like even when number of a button falling within the range to be enlarged is one.

The image generation apparatus according to the present invention is useful as an apparatus that facilitates operation on a small-sized panel at low development cost.

According to an embodiment of the present invention, the magnifying-glass enlarged button is associated with a portion outside the enlarged display area to make the button easy to identify, thereby facilitating the user's panel operation.

In addition, there is no need to develop a separate display program according the size of the touch panel. This makes it possible to suppress the development cost in a sense that the display can be produced in the same way regardless of variation in the size.

The correspondence display unit may produce the correspondence display only when a plurality of buttons is displayed in the enlarged display area.

The correspondence display unit may apply the same color to the same button and apply different colors to different buttons inside and outside the enlarged display area.

The colors may be applied such that the buttons are solidly filled with the colors, or the frames of the buttons are colored. Further, the colors applied to the buttons may be changed at predetermined time intervals.

The correspondence display unit may add the same reference sign to the same button and add different reference signs to different buttons inside and outside the enlarged display area. In this case, the reference signs are numbers, and the image generation apparatus may include a numeric keypad for accepting the entry of the numbers and an operation acceptance unit that accepts the entry of the numbers displayed for the buttons by the numeric keypad as button operation with the display of the numbers.

The correspondence display unit may not produce the display of the buttons with a character string therein in the enlarged display area. In this case, when there is a plurality of buttons with the same character string therein in the enlarged display area, the correspondence display unit may produce the display of the buttons. Further, when the number of the enlarged buttons is two and no button other than the two buttons is displayed in a predetermined area including the enlarged display area, the correspondence display unit may not produce the correspondence display.

The image generation apparatus includes for each button a state display unit that displays an additional image indicating the state of the button. When the enlarged display area overlaps the additional image on the original screen display, the state display unit may display the additional image in the enlarged display area.

When an area for preview display is included in the original screen display, the enlarged display unit may display the enlarged display area in an area other than the area for preview display.

The enlarged display unit may produce the enlarged display only when two or more buttons fall at least partly within the predetermined range.

Although the present invention has been described and illustrated in detail, it is clearly understood that the same is by way of illustrated and example only and is not to be taken by way of limitation, the scope of the present invention being interpreted by terms of the appended claims.

What is claimed is:

1. An image generation apparatus comprising:
a touch panel;
an enlarged display unit that enlarges an image within a predetermined range from a touch position and overlaps the enlarged image with an original screen display on a display screen of the touch panel;
an acceptance unit that accepts a button operation within an enlarged display area; and
a correspondence display unit that produces a correspondence display with correspondence between a button displayed in the enlarged display area and a non-enlarged portion of the button.

2. The image generation apparatus according to claim 1, wherein the correspondence display unit produces the correspondence display only when a plurality of buttons is displayed in the enlarged display area.

3. The image generation apparatus according to claim 1, wherein the correspondence display unit applies the same color to the same button and applies different colors to different buttons inside and outside the enlarged display area.

4. The image generation apparatus according to claim 3, wherein the colors are applied such that the buttons are solidly filled with the colors.

5. The image generation apparatus according to claim 3, wherein the colors are applied to the frames of the buttons.

6. The image generation apparatus according to claim 3, wherein the colors applied to the buttons are changed at predetermined time intervals.

7. The image generation apparatus according to claim 1, wherein the correspondence display unit adds the same reference sign to the same button and adds different reference signs to different buttons inside and outside the enlarged display area.

8. The image generation apparatus according to claim 7, wherein
the reference signs are numbers, and
the image generation apparatus includes:
a numeric keypad for accepting the entry of the numbers; and
an operation acceptance unit that accepts the entry of the numbers displayed for the buttons by the numeric keypad as button operation with the display of the numbers.

9. The image generation apparatus according to claim 1, wherein the correspondence display unit does not produce the display of the buttons with a character string therein in the enlarged display area.

10. The image generation apparatus according to claim 9, wherein, when there is a plurality of buttons with the same character string therein in the enlarged display area, the correspondence display unit produces the display of the buttons.

11. The image generation apparatus according to claim 1, wherein, when the number of the enlarged buttons is two and no button other than the two buttons is displayed in a predetermined area including the enlarged display area, the correspondence display unit does not produce the correspondence display.

12. The image generation apparatus according to claim 1, comprising for each button a state display unit that displays an additional image indicating the state of the button, wherein
when the enlarged display area overlaps the additional image displayed on the original screen display, the state display unit displays the additional image in the enlarged display area.

13. The image generation apparatus according to claim 1, wherein, when an area for preview display is included in the original screen display, the enlarged display unit displays the enlarged display area in an area other than the area for preview display.

14. The image generation apparatus according to claim 1, wherein the enlarged display unit produces the enlarged display only when two or more buttons fall at least partly within the predetermined range.

15. A non-transitory recording medium storing a computer readable image generation program executed by a computer of an image generation apparatus having a touch panel, the program causing the computer to execute:
enlarging an image within a predetermined range from a touch position and overlapping the enlarged image with an original screen display on a display screen of the touch panel;
accepting a button operation within an enlarged display area; and
producing a correspondence display with correspondence between a button displayed in the enlarged display area and a non-enlarged portion of the button.
